(19) United States
(12) Patent Application Publication
(10) Pub. No.: US 2005/0199140 A1
(43) Pub. Date: Sep. 15, 2005

(54) Automatic transmission system for a printer carriage drive

(76) Inventor: Wai Yuen Ho, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/789,744

(22) Filed: Feb. 27, 2004

(51) Int. Cl. B31F 1/07

(52) U.S. Cl. 101/10

(57) ABSTRACT

A carriage drive system is disclosed. The system includes a variable speed drive motor for propelling a movable carriage and a mechanism for switching between a gear ratio resulting in a high carriage speed and a gear ratio resulting in a low carriage speed. The mechanism for switching between the gear ratio resulting in a high carriage speed and the gear ratio resulting in a low carriage speed is actuated automatically.

### FIELD OF THE PRESENT INVENTION

The present invention relates generally to drive systems associated with electric motors and more particularly to a carriage drive system for use in inkjet printers.

### BACKGROUND TO THE PRESENT INVENTION

Inkjet printers operate using a print cartridge including a print head having one or more nozzles which spray drops of ink directly onto a print medium. One or more print cartridges are mounted on a carriage which is propelled laterally across the print medium depositing drops of ink on the print medium in a pattern to form an image. The movable carriage is typically driven back and forth across the print media by a timing belt driven by a pulley on a motor shaft.

FIG. 1 (Prior Art) shows a movable carriage 102 supporting print heads 104 having an ink ejecting nozzle 106. A slide rod 108 supports and guides the movable carriage 102, which is propelled along the slide rod 108 by a drive motor laterally across the print medium 110.

The carriage must be propelled smoothly across the print medium with a minimum of vibration so that the drops of ink can be placed accurately. This becomes particularly important during high-resolution printing. The more precisely the drops of ink are placed on the print medium, the higher the resolution of the images will be. Therefore, sources of vibration affecting the print cartridge must be minimized.

The dot density achievable by a particular print head arrangement is dependent on the firing frequency of the nozzles and the speed at which the carriage is propelled across the print medium. The carriage speed is in fact inversely proportional to the dot density. Since the firing frequency of the nozzles is typically limited to around 36 kHz, an increase in the dot density is achieved by reducing the speed at which the carriage is propelled laterally across the print medium.

Reducing the speed of the carriage has a tendency to cause carriage vibrations. When a two-pole DC electric motor is operated at a relatively low speed, the motor tends to operate less smoothly than it would at a higher motor speed. This is due to failure of the electromagnetic field to turn quickly enough on each half rotation of the electric motor to enable smooth operation of the motor. This result is sometimes referred to as a “cogging” effect. The “cogging” effect causes particular problems when trying to print at relatively high resolution since the misplacement of any dots of ink adversely affects the print resolution.

Whilst such difficulties typically arise when the motor is operating at relatively low speeds, it is also a requirement for the motor to be capable of propelling the carriage at relatively high speeds when operating the printer in a draft mode to achieve relatively low-resolution printing.

### SUMMARY OF THE PRESENT INVENTION

Briefly, the present invention provides a carriage drive system. The system includes a variable speed drive motor for propelling a movable carriage and a mechanism for switching between a gear ratio resulting in a high carriage speed and a gear ratio resulting in a low carriage speed. The mechanism for switching between the gear ratio resulting in a high carriage speed and the gear ratio resulting in a low carriage speed is actuated automatically.

### BRIEF DESCRIPTION OF THE DRAWINGS

FIG. 1 is a schematic drawing of a prior arrangement showing a moveable carriage which is propelled across a print medium along a slide rod by means of a drive motor.

FIG. 2A is a perspective view of the carriage drive system according to an embodiment of the invention.

FIG. 2B is an exploded view of the carriage drive mechanism of FIG. 2A according to an embodiment of the invention.

FIG. 2C is an enlarged view of the top of the carriage drive system of FIG. 2A according to an embodiment of the invention.

FIG. 3 is a flow chart showing a method of printing according to an embodiment of the invention.

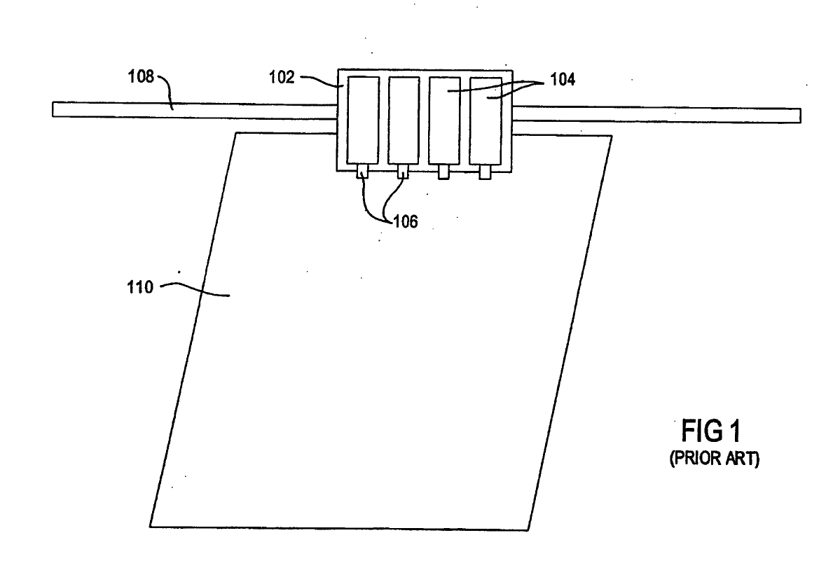

### DETAILED DESCRIPTION

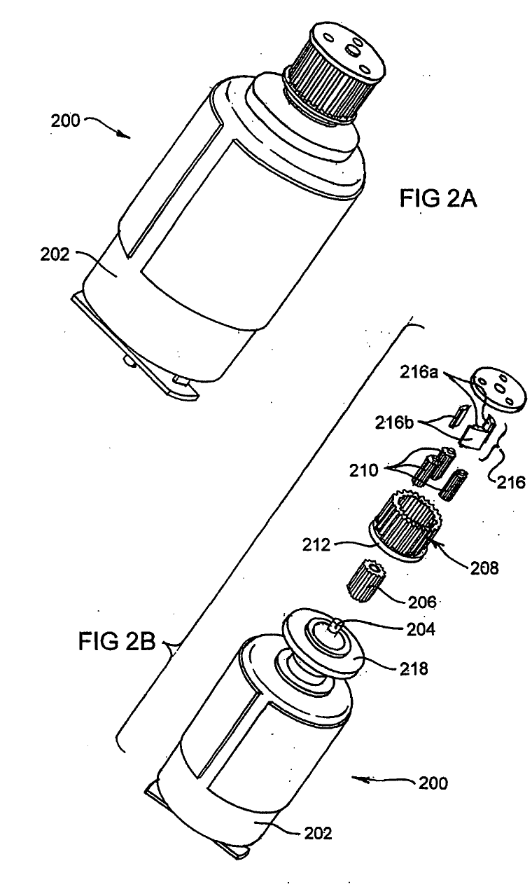

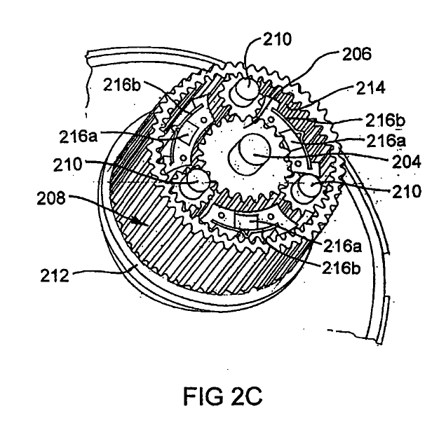

FIG. 2A shows an assembled carriage drive system 200. The system 200 includes a variable speed drive motor 202 for propelling a movable carriage on which one or more print cartridges are mounted. The movable carriage is propelled back and forth across the print media such that drops of ink may be deposited on the print medium in a desired pattern to form an image. The propelling force is supplied by the carriage drive system 200 of the present invention and may be interconnected with the movable carriage by a timing belt driven by a pulley on a motor shaft or any other suitable means apparent to those skilled in the art.

The carriage drive system 200 includes a mechanism 216 for switching between a gear ratio resulting in a high carriage speed and a gear ratio resulting in a low carriage speed. High carriage speeds may be suitable for low-resolution printing such as when the printer prints in “draft” mode, whilst low carriage speeds may be suitable when high-resolution is desired. Enabling the movable carriage to be driven at two discrete speeds makes it possible for the printer to provide both high- and low-resolution printing without encountering the “cogging” effects which may occur due to the pole-to-pole surge of DC motors.

The mechanism 216 for switching between the gear ratio resulting in a high carriage speed and the gear ratio resulting in a low carriage speed is actuated automatically. In one embodiment, this mechanism 216 is a centrifugal clutch 216.

Operation of the carriage drive system 200 will now be described with reference to FIG. 2B which shows an exploded view of the carriage drive system 200 shown in FIG. 2A. It is an advantage of the present invention that the need to operate the drive motor 202 itself at a low operational speed is negated. This overcomes the need to operate the drive motor 202 at lower speeds when it has a tendency to operate less smoothly and cause vibration of the movable carriage as it is propelled across the print medium. This benefit is a result of the use of a gearing mechanism, which enables a speed reduction to be induced when the drive motor 202 is operating at a relatively low speed.

In an embodiment, the gearing mechanism of the carriage drive system 200 is a planetary gear assembly. The planetary gear system may be of the type having a sun gear 206 driven by the drive motor 202, a ring gear 208 and a plurality of planet gears 210 associated with a planet carrier 212. The sun gear 206 engages the planet gears 210, which in turn engage the inside of the ring gear 208. The gear ratio that may be generated by the planetary gear system relates to the number of teeth 214 on the inside of the ring gear 208 and number of teeth on the sun gear 206. In the illustrated example this results in a ratio of 2:1.

Switching between gear ratios occurs by means of a centrifugal clutch 216. At relatively low motor speed the sun gear 206 turns the planet gears 210, which orbit the sun gear 206 and drive the ring gear 208. This results in a greater than 1:1 gear ratio, enabling a reduction in the speed of the movable carriage. That is, the ring gear 208 will rotate at a slower angular velocity than the sun gear 206. The exact range of gear ratios achievable by the system will depend on the factors described above in addition to additional features which may be added to the carriage drive system 200 in order to provide an adjustable gear ratio.

At high speed, a series of clutch weights 216a mounted on the planet carrier 212 move outwardly, against a clutch spring 216b, to engage the drive gear 208. The clutch weights 216a are moved outwardly by centrifugal acceleration. This causes the planet gears 210 and the ring gear 208 to lock together and rotate as one with the sun gear 206, thereby resulting in a 1:1 gear ratio. That is, the drive motor 202 effectively drives the carriage directly.

Conversely, when the drive motor 202 speed decreases sufficiently to overcome the centrifugal force which moves the clutch weights 216 outwards to engage the ring gear 208 by overcoming the biasing force of the clutch springs 216b, the clutch springs 216b return the clutch weights 216a back to their inactive position. The carriage drive system 200 thereby reverts to low speed operation as described previously.

In an embodiment, the carriage drive system 200 further includes a speed calibration member 218. The speed calibration member 218 provides for adjustment of the gear ratio between the drive motor 202 and the ring gear 208. The gear ratio between the drive motor 202 and the ring gear 208, is dependent on the degree of friction between the planet carrier 212 and the speed calibration member 218. The degree of friction is readily calibrated or adjusted by rotation of the speed calibration member 218.

In order to more clearly describe the effect of the speed calibration member 218 on the gear ratio between the drive motor 202 and the ring gear 208 the action of this member 218 at two operational extremes will be described. Note that in these scenarios the drive motor 202 is operating at a constant speed. For example, if the degree of friction between the planet carrier 212 and the speed calibration member 218 were equal to zero, the planet carrier 212 rotates freely and independently of the speed calibration member 218. Therefore, the sun gear 206 will drive the planet gears 210 and the ring gear 208 will remain stationary. This scenario produces an infinite gear ratio.

In contrast, if the speed calibration member 218 were adjusted causing it to rub against the planet carrier 212, adjustment may create a degree of friction sufficiently high for the speed calibration member 218 to frictionally engage the planet carrier 212, effectively locking them together. Therefore, the ring gear 208 will remain stationary whilst the sun gear 206 drives the planet gears 210. It is to be understood that the speed calibration member 218 itself remains stationary at all times.

FIG. 2C is an enlarged view of the top of the carriage drive system 200 of FIG. 2A showing more clearly the arrangement of the planet gears 210 and clutch weights 216a (three planet gears 210 and three clutch weights 216a are used in this example) around the sun gear 206. Since the clutch weights 216a are not functioning to disengage the ring gear 208 from the planet gears 210, the planet gears 210 are engaging the ring gear 208.

According to an alternate embodiment, the printer further includes a gearing mechanism 206, 208, 210, 212 having a gear ratio resulting in a high carriage speed and a gear ratio resulting in a low carriage speed and a mechanism 216 for switching between the gear ratios. The mechanism 216 for switching between the gear ratios is actuated automatically.

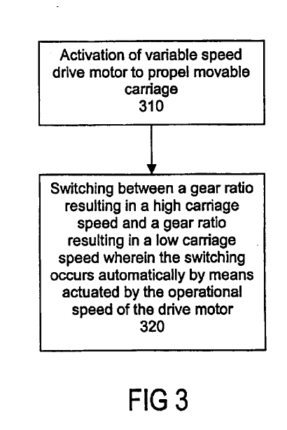

In an alternate embodiment, a method for printing is provided as shown in FIG. 3. A first step 310 includes activating a variable speed drive motor to propel a movable carriage. A final step 320 includes switching between a gear ratio resulting in a high carriage speed and a gear ratio resulting in a low carriage speed wherein switching between the gear ratio resulting in a high carriage speed and the gear ratio resulting in a low carriage speed occurs automatically by means actuated by the operational speed of the drive motor. The fundamental advantage of the carriage drive system 200 is that it reduces carriage vibrations resulting in improved accuracy in deposition of drops of ink. Other particular advantages derived from the carriage drive system 100 include the compact design of the system. The space efficient design makes the system particularly suitable for application in inkjet printers and the like, since efforts are constantly being made to reduce the footprint of such device to save desk space. Furthermore, the system is fully compatible with existing carriage drive system.

Although the present invention has been described in terms of the presently preferred embodiment, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

1. A carriage drive system, comprising:
a variable speed drive motor for propelling a movable carriage; and
a mechanism for switching between a gear ratio resulting in a high carriage speed and a gear ratio resulting in a low carriage speed wherein the mechanism for switching between the gear ratio resulting in a high carriage speed and the gear ratio resulting in a low carriage speed is actuated automatically.

2. A carriage drive system according to claim 1, wherein the mechanism for switching between the gear ratios is a centrifugal clutch.

3. A carriage drive system according to claim 1, wherein the gearing mechanism is a planetary gear assembly having:
a sun gear driven by the drive motor;
a ring gear; and
a plurality of planet gears associated with a planet carrier.

4. A carriage drive system according to claim 3, wherein operation of the drive motor at a high speed causes the mechanism for switching between gear ratios to engage the ring gear causing the planet gears and the drive gear to be locked together such that they rotate as one with the sun gear resulting in a 1:1 gear ratio and operation of the drive motor at a low speed causes the mechanism for switching between gear ratios to disengage the ring gear causing the sun gear to turn the planet gears which turn the ring gear resulting in a gear ratio greater than 1:1.

5. A carriage drive system according to claim 3, further comprising a speed calibration member for adjusting the gear ratio between the drive motor and the ring gear.

6. A carriage drive system according to claim 5, wherein the gear ratio between the drive motor and the ring gear is proportional to a friction force between the planet carrier and the speed calibration member.

7. A printer, comprising:
a movable carriage supporting print heads having an ink ejecting nozzle;
a slide rod for supporting and guiding the movable carriage;
a variable speed drive motor for propelling the movable carriage along the slide rod;
a gearing mechanism having a gear ratio resulting in a high carriage speed and a gear ratio resulting in a low carriage speed; and
a mechanism for switching between the gear ratios wherein the mechanism for switching between the gear ratios is actuated automatically.

8. A printer according to claim 7, wherein the mechanism for switching between the gear ratios is a centrifugal clutch.

9. A printer according to claim 7, wherein the gearing mechanism is a planetary gear assembly having:
a sun gear driven by the drive motor;
a ring gear; and
a plurality of planet gears associated with a planet carrier.

10. A printer according to claim 9, wherein operation of the drive motor at a high speed causes the mechanism for switching between gear ratios to engage the ring gear causing the planet gears and the drive gear to be locked together such that they rotate as one with the sun gear resulting in a 1:1 gear ratio and operation of the drive motor at a low speed causes the mechanism for switching between gear ratios to disengage the ring gear causing the sun gear to turn the planet gears which turn the ring gear resulting in a gear ratio greater than 1:1.

11. A printer according to claim 9, further comprising a speed calibration member for adjusting the gear ratio between the drive motor and the ring gear.

12. A printer according to claim 11, wherein the gear ratio between the drive motor and the ring gear is proportional to a friction force between the planet carrier and the speed calibration member.

13. A printer according to claim 12, wherein the speed calibration member is manually adjustable.

14. A method for printing, comprising:
activating a variable speed drive motor to propel a movable carriage;
switching between a gear ratio resulting in a high carriage speed and a gear ratio resulting in a low carriage speed;
wherein switching between the gear ratio resulting in a high carriage speed and the gear ratio resulting in a low carriage speed occurs automatically by means actuated by the operational speed of the drive motor.
